(19) United States
(12) Patent Application Publication
(10) Pub. No.: US 2011/0229790 A1
(43) Pub. Date: Sep. 22, 2011

(54) FUEL CELL MODULE AND FUEL CELL STACK

(76) Inventors: Kenji SATO, Toyota-shi (JP); Hiroo Yoshikawa, Toyota-shi (JP); Akito Kawasumi, Toyota-shi (JP)

(21) Appl. No.: 12/727,272

(22) Filed: Mar. 19, 2010

(51) Int. Cl. H01M 8/24

(52) U.S. Cl. 429/469

(57) ABSTRACT

A fuel cell stack and fuel cell modules that constitute such a fuel cell stack are provided, wherein adhesion of foreign materials to an electrolyte membrane of each fuel cell can be effectively prevented, and highly efficient maintenance is possible by replacing a fuel cell with degraded performance out of the fuel cell stack. A plurality of fuel cells 10 each having a membrane electrode assembly 1, gas-permeable layers 2,3,5,6 on the anode and cathode sides, sandwiching the membrane electrode assembly 1 therebetween, and a separator 7 on at least one of the anode and cathode sides are stacked. A gasket 8 is integrally molded with peripheral edges of the membrane electrode assembly 1 and the gas-permeable layers 2,3,5,6 of each of the stacked cells, whereby a single fuel cell module 100 is formed. Stacking and compressing such modules 100, . . . can form a fuel cell stack.

### BACKGROUND OF THE INVENTION

1. Field of the Invention

The present invention relates to a fuel cell module having a plurality of fuel cells and a gasket integrally molded therewith, and also relates to a fuel cell stack formed by stacking a plurality of such fuel cell modules and compressing them.

2. Background Art

A polymer electrolyte fuel cell has a membrane electrode assembly (MEA) which is formed from an ion-permeable electrolyte membrane and catalyst layers on the anode and cathode sides, the catalyst layers sandwiching the electrolyte membrane therebetween. Further, gas-flow-channel layers made of porous metal bodies for collecting electricity generated by electrochemical reactions as well as providing a fuel gas or an oxidant gas, and separators are provided on the opposite sides of the membrane electrode assembly. There is also known a cell configuration in which gas diffusion layers (GDL) are provided between the membrane electrode assembly and the porous metal bodies. An actual fuel cell stack is formed by stacking fuel cells in a number corresponding to the required amount of electricity to be generated and compressing them.

In each of the fuel cells with the aforementioned structure, a gasket, which is adapted to seal a fuel gas or an oxidant gas supplied to the membrane electrode assembly and also to seal a cooling medium such as cooling water for suppressing a temperature rise of the cell, is formed on the peripheral edges of the membrane electrode assembly and the gas-permeable layers such as gas diffusion layers. In conventional fuel cell stacks, a gasket is formed in each fuel cell. After a predetermined number of fuel cells each having a membrane electrode assembly and gas-permeable layers as well as a gasket formed on the peripheral edges thereof area stacked, they are compressed. Such a gasket is typically formed by injection molding. More specifically, the gasket is molded by, after sequentially disposing in a cavity of a molding die a separator on one of the anode and cathode sides, a gas-permeable layer adapted to function as a gas flow channel on one of the anode and cathode sides, a membrane electrode assembly, and a gas-permeable layer on the other of the anode and cathode sides, injecting resin into a cavity for molding the gasket on the peripheral edges of the membrane electrode assembly and the gas-permeable layers.

As exemplary configurations of separators, there are known a separator having gas-flow-channel grooves and cooling-medium-flow-channel grooves formed on the opposite sides of the separator, as well as a three-layer separator in which an intermediate layer with flow channels formed therein is provided between two plates made of titanium or stainless steel. As such a three-layer separator, there is also known a configuration in which a resin frame material is provided as the intermediate layer, and cooling-water flow channels are formed on one of the two plates by providing thereon a number of dimples or protruding ribs that define the flow channels. Such a three-layer separator serves as a separator on one of the anode and cathode sides of the cell as well as a separator on the other of the anode and cathode sides of an adjacent cell when the cells are stacked. When such a three-layer separator is used, a gas-flow-channel layer made of expanded metal or a porous metal body such as sintered metal foam is provided between the separator and the gas diffusion layer.

As described above, conventional fuel cell stacks are formed by stacking fuel cells with gaskets molded therewith and compressing them. In a fuel cell stack which is formed by stacking about 200 to 400 fuel cells, for example, a particular voltage sensor is provided in each fuel cell. When a fuel cell whose voltage has dropped below a predetermined value is identified, such a fuel cell is removed from the stack for replacement with another fuel cell.

However, it would be easy to understand that operations of releasing the stacking of a fuel cell stack, which is composed of a number of stacked fuel cells, and removing only a fuel cell that needs to be replaced, for replacement with another cell are very complex. Thus, improvement of such operations is demanded in the art.

An electrolyte membrane that partially constitutes a membrane electrode assembly is in fluid communication with the outside via a gas-permeable layer which is made of one or a combination of a porous gas diffusion layer and a porous metal body functioning as a gas-flow-channel layer. Properties of such an electrolyte membrane would be significantly degraded by contamination with foreign materials. Thus, a currently available fuel cell stack which is obtained by individually forming each fuel cell by injection molding and assembling such cells into a single unit has a possibility that an electrolyte membrane of each fuel cell may be contaminated with foreign materials during the injection molding process (e.g., contamination with a volatile gas) or during the assembling process. From such perspectives, it is inevitable to revise and improve the production method in which a fuel cell stack is formed by individually forming a gasket for each fuel cell by injection molding or the like and stacking the cells, and to improve the structure of a fuel cell stack formed with such a production method. Thus, development therefor is an urgent task to be accomplished. In particular, in the current situation in which fuel cell stacks have spread widely as stationary fuel cell stacks for use in houses or as mobile fuel cell stacks for use in hybrid vehicles, electric vehicles, and the like, it is necessary to achieve improvements in both the performance and productivity of such fuel cell stacks. In view of the foregoing, it is vial that fuel cell stacks that can effectively achieve the aforementioned urgent task be developed.

Focus is now shifted to the conventional public techniques. Reference 1 (JP Patent Publication (Kokai) No. 2008-123883 A) discloses a technique related to a method of producing a fuel cell stack which is aimed at an improvement of the assembling performance and disassembly performance of fuel cell stacks. However, since such a technique also includes the steps of individually forming a gasket for each fuel cell and stacking and compressing such cells, it cannot effectively achieve the aforementioned object. Reference 2 (JP Patent Publication (Kokai) No. 9-92324 A (1997)) discloses a technique related to a fuel cell module which is obtained by stacking a number of fuel cells and integrating such stacked cells by means of an engagement member having engagement parts on its opposite ends. Such a fuel cell module is formed by applying a pressing force to the stacked cells to elastically contract the entire stacked cells, allowing the engagement member to engage the stacked cells, and thereafter releasing the pressing force. However, it would be easy to understand that it is quite difficult to stack a number of cells, e.g., 200 cells and maintain the compressed state, that is, to maintain the state of a large number of compressed stacked cells until they become engaged with the engagement member. Further, there is a doubt as to whether such an engagement member has sufficient strength (resistance force) against a tensile force that is received from the expanded stacked cells after the compressive force is released. Even if a sufficient resistance force against such a tensile force is ensured after the compressive force is released, it would be difficult to expect long-term durability of the engagement member as long as it is continuously receiving the tensile force. Further, Reference 3 (JP Patent Publication (Kokai) No. 2000-133291 A) discloses a technique related to a fuel cell stack in which the periphery of stacked cells is sealed with a phenol resin layer or the like so that the entire stacked cells are integrated. However, since this technique only seals the periphery of the stacked cells of the fuel cell stack with the sealing material, it would be impossible to provide fluid sealing properties between the cells inside the sealing material.

### SUMMARY OF THE INVENTION

The present invention is made in view of the foregoing problems. It is an object of the present invention to provide a fuel cell stack and fuel cell modules that constitute such a fuel cell stack, in which an electrolyte membrane of each fuel cell that forms the fuel cell stack can be effectively prevented from contamination (e.g., adhesion) with foreign materials, and with which effective maintenance can be carried out by, for example, removing only a fuel cell with degraded performance out of the fuel cell stack for replacement.

In order to achieve the aforementioned object, a fuel cell module in accordance with the present invention is composed of a plurality of stacked fuel cells each of which has a membrane electrode assembly, gas-permeable layers on the anode and cathode sides, the gas-permeable layers sandwiching the membrane electrode assembly therebetween, and a separator on at least one of the anode and cathode sides. Further, a gasket is integrally molded with the peripheral edges of the membrane electrode assembly and the gas-permeable layers of each of the stacked fuel cells, whereby a single module is formed.

A fuel cell module of the present invention has a plurality of fuel cells assembled as a single module. Such a fuel cell module is formed by, for example, disposing (constituent members of) a plurality of fuel cells in a molding die and concurrently forming gaskets of the fuel cells by injection molding, whereby a module with a plurality of cells that are joined by the integrally molded gaskets is provided.

Thus, when a single module is constructed from 30 fuel cells, for example, membrane electrode assemblies of the 28 interior fuel cells, except those located on the opposite sides of the module, can be completely shielded from the outside during the injection molding process, whereby it is possible to prevent an electrolyte membrane of such a membrane electrode assembly from contamination with foreign materials.

In maintenance of a fuel cell stack after its service, replacement can be conducted not on the cell basis, but on the module basis. That is, since cells included in a single module cannot be separated due to the presence of gaskets integrally molded therewith, and since adjacent modules are only detachably in contact with each other (a sealing structure is formed with the contact portion), it is possible to easily remove a module that includes a cell with degraded performance and thus to easily reproduce a fuel cell stack.

Such fuel cell modules come in various sizes. When it comes to a single fuel cell stack having 300 stacked fuel cells, for example, a single module can be constructed from about 2 to 50 cells. Alternatively, it is also possible to form a single module by integrally molding 300 cells with gaskets so that the single module constitutes a fuel cell stack. It should be noted that a fuel cell stack formed from a single cell module that is assembled by integrating a plurality of fuel cells can also be referred to as a “multi-cell, single-module fuel cell stack.”

Each fuel cell that constitutes such a module includes a membrane electrode assembly, gas-permeable layers on the anode and cathode sides, and a separator on at least one of the anode and cathode sides (there are known configurations in which a separator is provided on only one or each of the anode and cathode sides). The “gas-permeable layer” as referred to herein means both a gas diffusion layer and a gas-flow-channel layer. That is, in a cell configuration without a gas-flow-channel layer, the “gas-permeable layer” means a “gas diffusion layer,” whereas in a cell configuration with both a gas diffusion layer and a gas-flow-channel layer, the “gas-permeable layer” means either one or both of the “gas diffusion layer” and the “gas-flow-channel layer.” Further, either of the following configurations is possible: a configuration in which a gas diffusion layer made up of a diffusion-layer base material and a current-collecting layer is provided on each of the anode and cathode sides of the membrane electrode assembly, or a configuration in which only a current-collecting layer is provided (a diffusion-layer base material is discarded) on one of the anode and cathode sides. It should be noted that in a fuel cell, a region that includes a catalyst layer, in particular, of a membrane electrode assembly and gas-permeable layers corresponding to the catalyst layer serves as a power-generation region, while a region that includes a gasket molded on the peripheral edge of the power-generation region serves as a non-power-generation region.

When a fuel cell includes gas-flow-channel layers, porous metal bodies that constitute the gas-flow-channel layers are preferably formed from expanded metal or sintered metal foam. For the sintered foam, highly corrosion-resistant metal materials such as titanium, stainless steel, copper, or nickel are preferably used. It is also possible to use foam obtained by dispersing chromium carbide or iron-chromium carbide in stainless steel.

For the separator, it is possible to use the aforementioned three-layer separator, for example, as well as a typical conventional separator which has flow-channel grooves for circulating gas or a cooling medium. For the three-layer separator, in particular, any of the following configurations can be used: a configuration with two metal plates made of conductive metals (e.g., stainless steel or titanium) and an intermediate layer sandwiched therebetween, the intermediate layer having formed therein cooling-medium flow channels made of metal materials, and a configuration with a an intermediate layer made of a resin frame material and two metal plates, wherein one of the metal plates has a number of dimples or protruding ribs for defining flow channels. In a configuration in which a number of dimples are provided in an intermediate layer, a cooling medium such as cooling water flows from a supply manifold to a discharge manifold while at the same time forming a turbulent flow with the dimples, thereby cooling the membrane electrode assembly.

Exemplary materials of the gasket, which is molded on the peripheral edges of the membrane electrode assembly and the gas-permeable layers by injection molding or the like, include butyl rubber, urethane rubber, silicone RTV rubber, methanol-resistant epoxy resins, epoxy-modified silicone resins, silicone resins, fluorocarbon resins, and hydrocarbon resins.

According to the aforementioned fuel cell modules or fuel cell stack formed from such cell modules of the present invention, a fuel cell stack is formed from a so-called multi-cell, single-module fuel cell stack, whereby it is possible to effectively prevent electrolyte membranes of most of the fuel cells that constitute the fuel cell stack from contamination with foreign materials in the production process. Further, the maintenance efficiency is significantly improved by removing only a module that includes a fuel cell with degraded performance. According to the empirical rule of the inventors et al., it has been identified that degradation in performance of a fuel cell is caused by degradation in performance of a plurality of fuel cells including neighboring cells, rather than degradation in performance of a single cell, and that a portion in which performance could degrade within a cell tends to be substantially common to each of the cells. This can also confirm the fact that even more effective maintenance can be realized by conducting replacement on the module basis.

In the aforementioned module structure, the separator has a protruding portion that protrudes laterally to the outer peripheral surface of the gasket, beyond the membrane electrode assembly and the gas-permeable layers, whereby a stacked structure of the gasket and the protruding portion of the separator is formed.

That is, in the fuel cell module of the present invention, a protruding portion of the separator, which protrudes laterally beyond the membrane electrode assembly and the like, extends to the outer peripheral surface of the gasket, that is, to the outer peripheral surface of the cell module. Thus, the peripheral edge of the module has a laminate structure of the protruding portion of the metal separator and the gasket located on each side (or each of the top and bottom surfaces) of the protruding portion, whereby the rigidity of the peripheral region of the module can be extremely high. Thus, in comparison with the rigidity of a module with a unitary construction with a gasket made of a thermoplastic resin material or the like, which is formed on the peripheral edge of the module, the rigidity of the peripheral edge of the module of the present invention can be significantly higher, whereby it is possible to prevent problems such as a decrease in modulus of elasticity of the peripheral edge under the high-temperature atmosphere during the power generation operation and also prevent shrinkage.

In the fuel cells in accordance with another embodiment of the fuel cell module of the present invention, a plurality of manifolds for circulating at least one of a fuel gas, an oxidant gas, and a cooling medium are formed. Separators are provided on the opposite sides of each module. A first endless sealing material which is adapted to surround each manifold is provided between separators of adjacent modules.

According to such embodiment, three-layer separators, for example, are provided on opposite ends (opposite sides) of each module, and an endless sealing material (a first sealing material) is provided between the adjacent modules around the manifold for circulating fluids formed in both the modules. In the protruding portion of the aforementioned separator, an opening for fluids is provided coaxially with the manifold of the gasket, and the end portion of the protruding portion extends to the outer peripheral surface of the gasket.

The first sealing material herein is, for example, an O-ring (whose linear shape can be any of a circle, rectangle, square, and the like) made of a metal material, a fixed-shape ring made of a resin material, or the like. The sealing material is moderately squashed when a plurality of modules are stacked and compressed, whereby a fluid sealing structure can be formed around the manifold.

Each module has separators formed on its opposite sides, and a sealing material is provided between separators of adjacent modules. Accordingly, it is possible, in maintenance, to further increase the maintenance efficiency by releasing the stacking and removing a sealing material provided around a module to be removed as well as the module and building a new module as well as a new sealing material into the stack. Further, since a new sealing structure can be formed between the modules with the new sealing material in maintenance, it is possible to prevent a decrease in sealing properties of the fuel cell stack, which would otherwise be caused by the maintenance.

In the embodiment of the fuel cell modules, at least one of the opposed surfaces of the separators of the adjacent modules has an endless concave groove formed therein, around the manifold. In a state in which the adjacent modules are stacked, part or all of the first sealing material can be received in an endless space that is defined by the concave grooves of the two separators or in an endless space that is defined by the concave groove of one of the separators and a planar surface of the other separator.

According to such embodiment, an endless concave groove is formed on at least one of the opposed surfaces of the separators of the adjacent modules (which may be only one or both of the opposed surfaces of the two separators) around the manifold. In a state in which the modules are stacked, an endless space is formed by the concave grooves of the two separators or by the concave groove of one of the separators and a planar surface of the other separator. Disposing the aforementioned sealing material in such a space allows positioning of the sealing material to be carried out easily, whereby misalignment of the sealing material in stacking can be prevented.

Further, when the disposed sealing material is completely squashed by a compressive force that acts in stacking, which in turn brings the adjacent separators into surface contact with each other, a serial flow of electric current, which is generated in the stacked direction of the modules (a flow generated in collecting electric current), can be formed.

According to a preferred embodiment of the fuel cell module of the present invention, the peripheral edge of the separator is covered with the gasket such that the gasket is continuous over the peripheral edge of a single module.

According to such embodiment, the peripheral edge of the separator, which has been conventionally exposed to the outside, is completely covered with the gasket, whereby the separator can be electrically insulated from the outside. It should be noted that a fuel cell stack with a conventional structure is stored in a case made of an insulating material such as resin, so that the separator is insulated from the outside.

According to such embodiment, separators of fuel cells that constitute a module are completely covered with a gasket, whereby it is possible to form a structure in which all of the separators of the fuel cell module or the fuel cell stack are completely insulated from the outside with the use of the gasket. Thus, it is possible to eliminate the need for a conventional case made of an insulating material, thereby contributing to further reductions in size and weight of the fuel cell stack.

According to another embodiment of the fuel cell modules of the present invention, a second elastic, endless sealing material is provided between the peripheral edges of the opposed end surfaces of the adjacent modules.

A gas diffusion layer (GDL) of each fuel cell is elastic, and is designed such that it is formed to be somewhat thick in the stacked direction of the cells before the cells are stacked. Such a gas diffusion layer is, when the cells are stacked, adapted to be compressed by elastic deformation, and a compressive force generated in stacking is made to act upon each membrane electrode assembly.

Further, according to still another embodiment of the fuel cell modules of the present invention, in comparison with a power-generation region that includes the membrane electrode assembly and the gas-permeable layer, a non-power-generation region that includes the gasket formed on the peripheral edge of the power-generation region has a shape such that it swells in the stacked direction of the fuel cells. Accordingly, when a plurality of such modules are stacked and compressed, the power-generation region and the non-power-generation region of each module can be flat.

As can be understood from the foregoing description, according to the fuel cell modules or the fuel cell stack formed by stacking such modules of the present invention, there are provided a module having a plurality of fuel cells and a gasket integrally molded therewith, and a fuel cell stack formed by stacking a plurality of such modules, whereby most of the electrolyte membranes of the fuel cells that constitute the fuel cell modules or the fuel cell stack can be effectively protected against contamination with foreign materials in the production process of the fuel cell modules or stack. Further, the maintenance efficiency can be significantly improved not by removing a single fuel cell with degraded performance but by removing, after releasing the stacking, a module that includes one or more fuel cells with degraded performance, for replacement with a new module. Further, high sealing properties between the modules around the manifolds can be provided. When a configuration in which separators are covered with a gasket is used, it is also possible to provide a fuel cell stack with excellent electrical insulation properties from the outside.

### BRIEF DESCRIPTION OF THE DRAWINGS

In the accompanying drawings:

FIG. 1 is a longitudinal cross-sectional view showing an embodiment of a module having a plurality of fuel cells and a gasket integrally molded therewith;

FIG. 2 is a longitudinal cross-sectional view showing another embodiment of a module;

FIG. 3 is a longitudinal cross-sectional view showing still another embodiment of a module and a fuel cell stack formed by stacking such modules;

FIG. 4 is a longitudinal cross-sectional view showing yet another embodiment of a module;

FIG. 5 illustrates a problem that arises in stacking modules; and

FIG. 6 is a longitudinal cross-sectional view showing yet another embodiment of a module and a fuel cell stack formed by stacking such modules.

### DESCRIPTION OF SYMBOLS

1 membrane electrode assembly (MEA)
2 gas diffusion layer (gas-permeable layer) on the cathode side
3 gas diffusion layer (gas-permeable layer) on the anode side
4 electrode body
5 gas-flow-channel layer (gas-permeable layer, porous metal body) on the cathode side
6 gas-flow-channel layer (gas-permeable layer, porous metal body) on the anode side
7 separator
71, 72 metal plates
73 intermediate layer for forming flow channels
7a gas flow channel
8, 8A, 8B gaskets
8a endless sealing rib
9 first sealing material (O-ring)
9A second sealing material
10, 20 fuel cells
100, 200, 300, 400 modules
1000, 2000 fuel cell stacks
M manifold

### DETAILED DESCRIPTION OF THE PREFERRED EMBODIMENTS

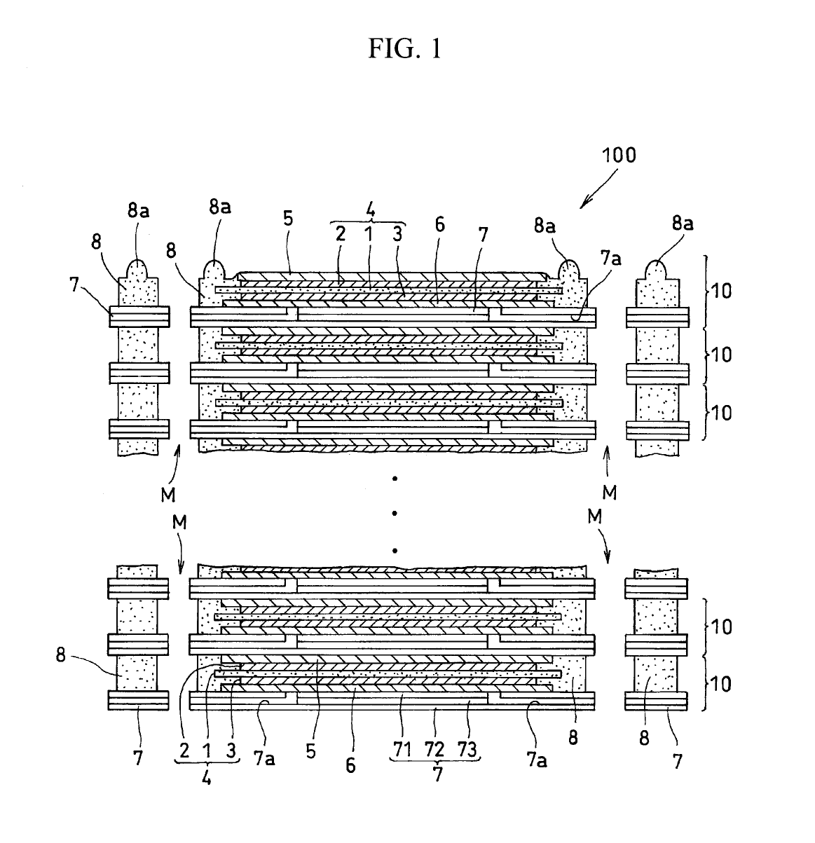

Hereinafter, embodiments of the present invention will be described with reference to the accompanying drawings. FIG. 1 is a longitudinal cross-sectional view showing an embodiment of a module having a plurality of fuel cells and a gasket integrally molded therewith. This module 100 has a stack of, for example, 10 to 50 fuel cells 10, . . . and a gasket 8 integrally molded therewith.

Each fuel cell 10 includes a three-layer separator 7 (in the drawing, a separator on the anode side is shown); a gas-flow-channel layer 6 (a gas-permeable layer) made of a porous metal body on the anode side; an electrode body 4 having a membrane electrode assembly 1 and gas diffusion layers 2 and 3 (both of which are gas-permeable layers) on the cathode and anode sides; and a gas-flow-channel layer 5 (a gas-permeable layer) made of a porous metal body on the cathode side. In addition to the example shown in the drawing, it is also possible to use any of the following cell structures: a cell structure with not a three-layer separator but with a separator having flow-channel grooves for circulating gas or a cooling medium, a cell structure without gas-flow-channel layers made of porous metal bodies (gas-flow-channel layers are not necessarily required when a structure with a separator having flow-channel grooves is used), and a cell structure with only one of the gas diffusion layers 2 and 3.

Herein, an electrolyte membrane that partially constitutes the membrane electrode assembly 1 is made of, for example, a fluorine-containing ion-exchange membrane with a sulfonic acid group or a carbonyl group; non-fluorine-containing polymers such as substituted polyphenylene oxide, sulfonated poly(aryl ether ketone), sulfonated poly(aryl ether sulfone), and sulfonated polyphenylene sulfide; or the like.

A catalyst layer is formed through the steps of producing a catalyst solution (catalyst ink) by mixing a conductive carrier carrying a catalyst (e.g., a particulate carbon carrier), an electrolyte, and a dispersion solvent (an organic solvent), applying the catalyst solution in the form of a layer onto a substrate such as an electrolyte membrane or a gas diffusion layer using a blade coater, thereby forming a coating, and drying the coating with a hot-air drying oven and the like. Examples of electrolytes that partially form the catalyst solution include ion exchange resin having fluorine-containing organic polymers, which are proton conductive polymers, in its skeleton, such as perfluorocarbon sulfonic acid resin; sulfonated plastic electrolytes such as sulfonated polyetherketone, sulfonated polyethersulfone, sulfonated polyetherethersulfone, sulfonated polysulfone, sulfonated polysulfide, and sulfonated polyphenylene; and sulfoalkylated plastic electrolytes such as sulfoalkylated polyetheretherketone, sulfoalkylated polyethersulfone, sulfoalkylated polyetherethersulfone, sulfoalkylated polysulfone, sulfoalkylated polysulfide, and polyalkylated polyphenylene. Examples of commercially available materials are Nafion (registered trademark; produced by DuPont) and Flemion (registered trademark; produced by ASAHI GLASS CO., LTD.). Examples of dispersion solvents include alcohols such as methanol, ethanol, 1-propanol, 2-propanol, ethylene glycol, and diethylene glycol; acetone; methylethylketone; dimethylformamide; dimethylimidazolidinone; dimethylsulfoxide; dimethylacetamide; N-methylpyrrolidone; esters such as propylene carbonate, ethyl acetate, and butyl acetate; and various solvents such as aromatic solvents and halogen solvents. Such solvents can be used either alone or in combination as a mixed solution. Further, for the conductive carrier carrying a catalyst, it is possible to use carbon materials such as carbon black, carbon nanotubes, and carbon nanofibers, carbon compounds typified by silicon carbide, and the like. For the catalyst (metallic catalyst), it is possible to use, for example, one of platinum, platinum alloys, palladium, rhodium, gold, silver, osmium, and iridium. Preferably, platinum or platinum alloy is used. Examples of platinum alloys include alloys of platinum and one or more of aluminium, chromium, manganese, iron, cobalt, nickel, gallium, zirconium, molybdenum, ruthenium, rhodium, palladium, vanadium, tungsten, rhenium, osmium, iridium, titanium, and lead.

Each of the gas diffusion layers 2 and 3 includes, for example, a diffusion-layer base material and a current-collecting layer (MPL). The diffusion-layer base material is not particularly limited as long as it has low electrical resistance and is capable of collecting current. For example, a material which is mainly composed of a conductive inorganic substance can be used. Examples of such conductive inorganic substances include baked polyacrylonitrile, baked pitch, carbon materials such as graphite and expanded graphite, nanocarbon materials thereof, stainless steel, molybdenum, and titanium. The form of the conductive inorganic substance of the diffusion-layer base material is not particularly limited. For example, the conductive inorganic substance is used in a fibrous form or a particulate form. However, conductive inorganic fibers, in particular, carbon fibers are preferably used in terms of gas permeability. As the diffusion-layer base material using conductive inorganic fibers, either a woven fabric or a nonwoven fabric can be used. For example, carbon paper, carbon cloth, or the like can be used. The woven fabrics are not particularly limited; examples include plain-woven fabrics, figured fabrics, and tapestry. Examples of nonwoven fabrics include those formed by a paper-making method, a needle punch method, and a water jet punch method. Further, examples of carbon fibers include phenol-based carbon fibers, pitch-based carbon fibers, polyacrylonitrile (PAN)-based carbon fibers, and rayon-based carbon fibers. Further, the current-collecting layer has a function of collecting electrons from the catalyst layers on the anode and cathode sides, and can be formed from conductive materials such as platinum, palladium, ruthenium, rhodium, iridium, gold, silver, and copper; compounds or alloys thereof; conductive carbon materials, or the like.

Though not shown in the drawing, a protective polymer film having functions of preventing fuzz, which protrudes from the gas diffusion layer, from sticking out to the electrolyte membrane and reinforcing the electrolyte membrane against a gasket that is to be formed by injection molding is preferably provided in an exposed region of the peripheral edge of the catalyst layer in which the catalyst layer is not in close contact with the electrolyte membrane. Examples of such protective polymer films include films formed from polytetrafluoroethylene, PVDF (polyvinylidene difluoride), polyethylene, polyethylene naphthalate (PEN), polycarbonate, polyphenylene ether (PPE), polypropylene, polyester, polyamide, copolyamide, polyamide elastomer, polyimide, polyurethane, polyurethane elastomer, silicone, silicone rubber, and silicone-based elastomer.

The porous metal bodies 5 and 6 functioning as the gas-flow-channel layers can be formed from expanded metal, sintered metal foam, or the like. For example, porous metal bodies, which are made of sintered foam of highly corrosion-resistant metal materials such as titanium, stainless steel, copper, and nickel, form the gas-flow-channel layers.

The module 100 shown in FIG. 1 is obtained by disposing, for example, a predetermined number of fuel cells 10, . . . in a molding die (not shown), and injecting, in such a state, resin into a cavity to form the gasket 8, whereby the module 100 having the gasket 8 integrally formed therewith is obtained.

The gasket 8 is formed from resin materials such as butyl rubber, urethane rubber, silicone RTV rubber, methanol-resistant epoxy resins, epoxy-modified silicone resins, silicone resins, fluorocarbon resins, and hydrocarbon resins.

In the example shown in the drawing, an endless sealing rib 8a for surrounding a manifold M is provided at the upper end of the gasket 8. The rib 8a is adapted to be squashed when the module 100 is stacked and compressed, so that a sealing structure can be formed.

FIG. 1 shows a module cut along cross sections that pass through, for example, a fuel-gas supply manifold M and a fuel-gas discharge manifold M. In a state in which the fuel cells 10, . . . that constitute the module 100 are stacked, the manifolds M in fluid communication with the outside are formed in the stacked direction of the fuel cells 10. FIG. 1 shows a structure in which a fuel gas supplied from the manifold M is provided to the gas-flow-channel layer 6 on the anode side via a gas flow channel 7a in the three-layer separator 7. Thus, another manifold for providing an oxidant gas to the gas-flow-channel layer 5 on the cathode side is formed in the other cross section.

The three-layer separator 7 has metal plates 71 and 72 made of stainless steel or titanium and an intermediate layer 73 sandwiched therebetween, the intermediate layer 73 having formed therein a cooling-water flow channel made of a metal material. However, it is also possible to provide a configuration in which a resin frame material is provided as the intermediate layer, and either one of the two metal plates has formed thereon a number of dimples or protruding ribs for defining flow channels.

For example, provided that the module 100 shown in FIG. 1 is made up of 20 fuel cells 10, . . . , when a fuel cell stack having 300 fuel cells 10, . . . is to be constructed, such a fuel cell stack is formed by stacking 15 pieces of the modules 100 shown in FIG. 1. Upon completion of the module 100, the electrode body 4 of each fuel cell 10 is sandwiched between the separators 7, 7 on the anode and cathode sides (one of such separators 7 is a separator of an adjacent cell) with the gas-flow-channel layers 5, 6 therebetween.

As is obvious from the drawing, most of the electrolyte membranes of the fuel cells 10, . . . that constitute the module 100 are adapted to be non-contactable with external foreign materials during the injection molding process due to the plurality of cells being stacked. Thus, such electrolyte membranes can be prevented from contamination with a volatile gas and the like during the injection molding process, in particular. Further, such electrolyte membranes can also be prevented from contamination with floating foreign materials and the like in the process of stacking the cells.

The peripheral edge of the module 100 has a laminate structure of the three-layer separator 7 and the gasket 8 such that the three-layer separator 7 protrudes laterally beyond the electrode body 4, and the gasket 8 is disposed on the top and bottom of part of the protruding portion. Thus, the rigidity of the peripheral region of the module 100 is extremely high.

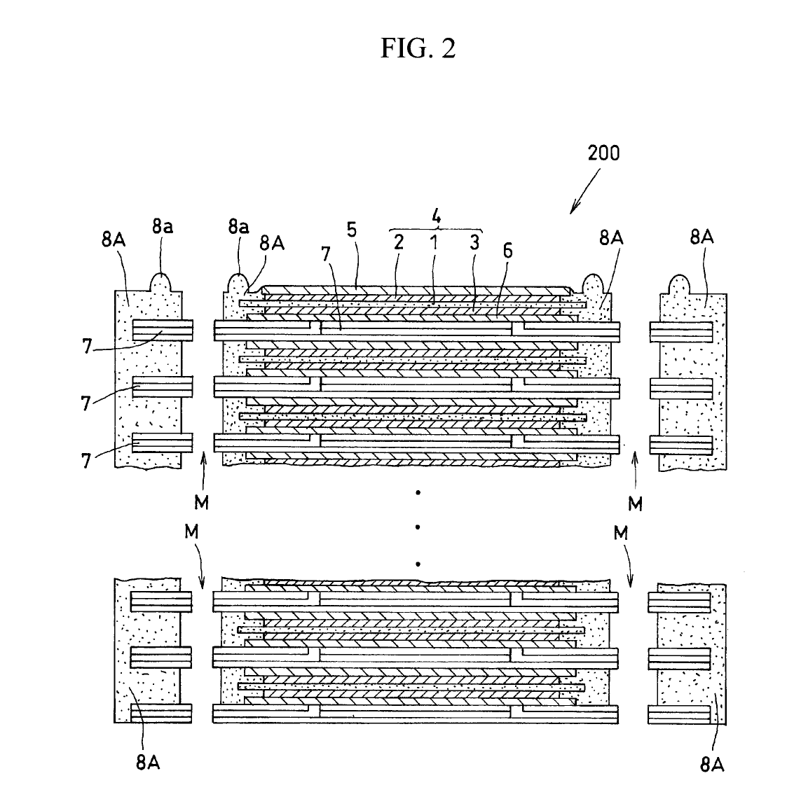

FIG. 2 shows a variation of FIG. 1. Specifically, FIG. 2 shows a module 200 in which the three-layer separator 7 is completely covered with a gasket 8A.

In such a module 200, end portions of the separator 7 can be completely insulated from the outside. Thus, the fuel cell stack can be electrically insulated without using an insulating resin case or the like for storing a conventional fuel cell stack, for example.

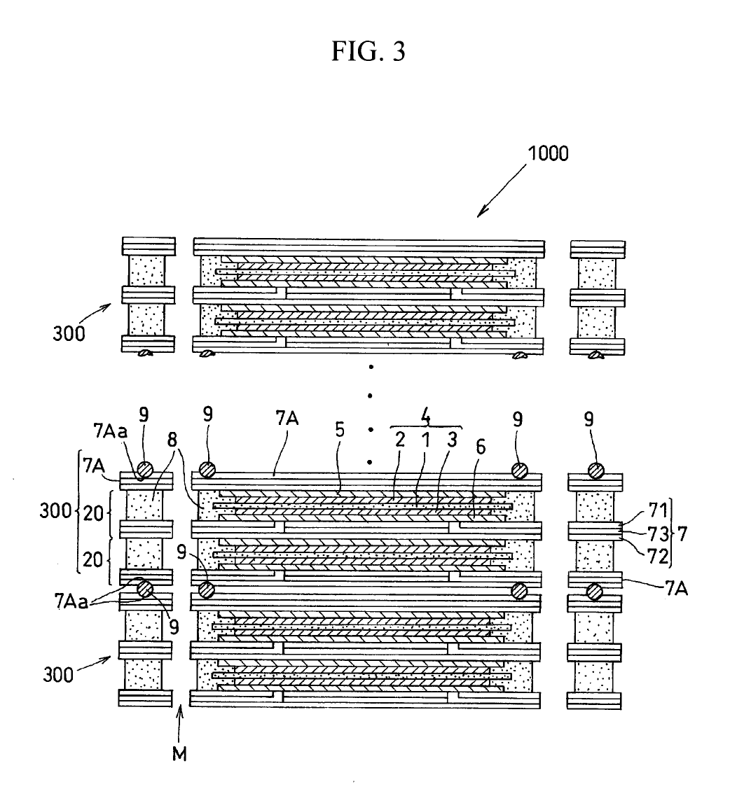

FIG. 3 shows still another embodiment of the module. This module 300 has two fuel cells 20, 20 and a gasket 8 integrally formed therewith as shown. Further, on a side where the three-layer separator 7A is not provided, another separator 7A is provided (separators 7A, 7A are provided on the opposite sides of the module 300). An endless concave groove 7Aa, which is adapted to receive part of a first endless sealing material 9 (O-ring), is formed in the separator 7A around the manifold M. In a state in which the modules 300, 300 are stacked, concave grooves 7Aa, 7Aa of the two modules can together form a space for receiving part of the sealing material 9, so that the sealing material 9 is fixedly positioned within the space. Such a concave groove can be formed only in one of the separators, in which case a space is formed between the concave groove and a planar surface of the other separator.

In the example shown herein, a gap is formed between the stacked modules 300, 300. However, when the modules are stacked, the sealing material 9 is squashed, which in turn allows the separators 7A, 7A of the modules 300, 300 to make surface contact with each other.

Stacking a desired number of the modules 300, . . . and compressing them forms a fuel cell stack 1000.

When the fuel cell stack 1000 as shown is used, it is possible to release the stacking when removing a module 300 that includes a fuel cell with degraded power-generation performance, and to thereafter easily remove the sealing material 9 and the relevant module 300. Further, disposing a new sealing material 9 at each end of a new module 300 and compressing them allows the maintenance to be carried out in an extremely simple way. Moreover, even after the maintenance, a new fuel cell stack 1000 can be reproduced without degrading the sealing performance of the module at the replaced portion.

Further, though not shown, it is also possible to produce modules in which, in comparison with a power-generation region that includes a membrane electrode assembly and a gas-permeable layer, a non-power-generation region that includes a gasket formed on the peripheral edge of the power-generation region has a shape such that it swells in the stacked direction of the fuel cells. Stacking and compressing such modules allows the power-generation region and the non-power-generation region of each module to be flat.

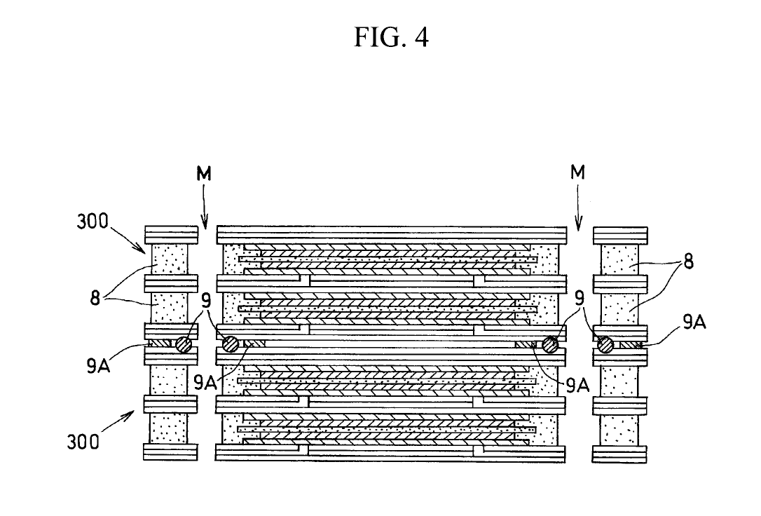

FIG. 4 shows part of a fuel cell stack in which a second sealing material 9A made of an elastic material, which is adapted to surround the manifold M, is further provided on the periphery of the first sealing material 9.

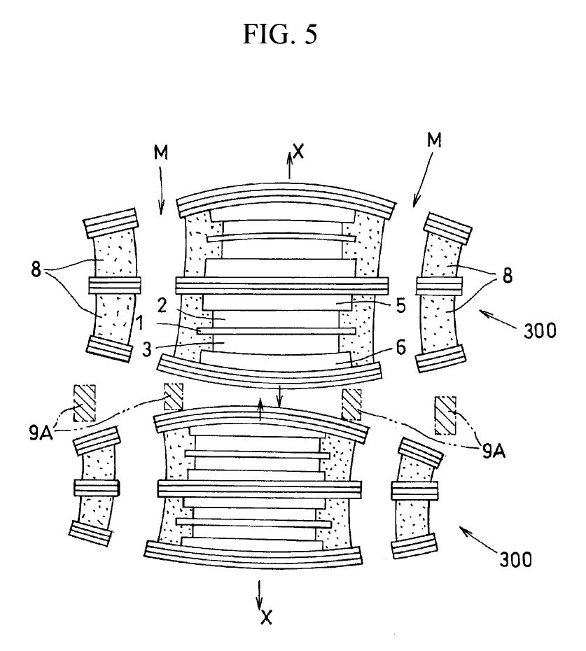

A gas diffusion layer (GDL) of each fuel cell is elastic and is designed such that it is formed to be somewhat thick in the stacked direction of the cells before the cells are stacked, so that the gas diffusion layer is, when the cells are stacked, adapted to be compressed by elastic deformation, and a compressive force generated in stacking is made to act upon each membrane electrode assembly. Thus, when a plurality of fuel cells are joined with gaskets to thereby form a single module 300 as shown in FIG. 5, it follows that the central region of the module 300 could swell toward the outer side (X direction) and thus could be in the shape of a so-called drum because gas diffusion layers designed to be thick are stacked in a number corresponding to the number of the cells that constitute the module whereas end portions of the module are fixed with the gaskets. When such drum-shaped modules 300, 300 whose central regions swell toward the outer side and whose peripheral edges sink are stacked, the modules 300, 300 could abut in the central region, and a gap could be generated between the peripheral edges of the modules in regions in which the manifolds M, M are formed, with the result that fluid sealing properties of the modules around the manifolds M cannot be provided.

Thus, providing a second endless sealing material 9A, for example, which is made of rubber and is relatively thick, around each manifold M as indicated by the chain double-dashed lines in FIG. 5 and compressing it allows the gap between the modules 300, 300 to be completely closed by the sealing material 9A as shown in FIG. 4, whereby sealing properties of the modules around the manifolds M can be provided.

The example herein shows a structure in which the first sealing material 9 made of an O-ring is provided, and also the second sealing material 9A made of rubber is provided on the periphery of the first sealing material 9. However, when the first sealing material 9 is made of rubber, the second sealing material 9A can be omitted.

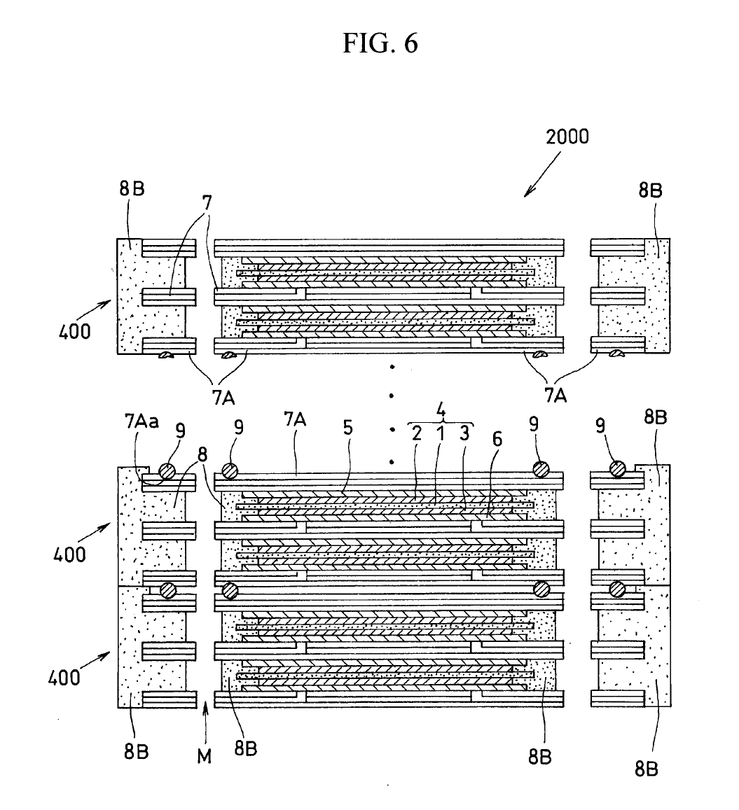

FIG. 6 shows a variation of FIG. 3. Specifically, FIG. 6 shows modules 400 each with a structure in which three-layer separators 7, 7A are completely buried in gaskets 8B. A desired number of such modules 400, . . . are stacked and compressed to form a fuel cell stack 2000.

The aforementioned fuel cell stack has, on its outermost sides, end plates, tension plates, and the like. Such a fuel cell stack is formed by applying a compressive force between the tension plates on the opposite ends. A fuel cell system mounted on an electric vehicle or the like is mainly composed of such a fuel cell stack, various tanks for storing hydrogen gas and air, a blower for providing such gas to the fuel cells, a radiator for cooling the fuel cells, a battery for accumulating electricity generated by the fuel cells, and a drive motor driven with such electricity.

Although embodiments of the present invention have been specifically described above with reference to the accompanying drawings, specific structures of the present invention are not limited to such embodiments. Any design variations and modifications are possible without departing from the spirit and scope of the present invention.

1. A fuel cell module comprising:
a plurality of stacked fuel cells each including a membrane electrode assembly, gas-permeable layers on anode and cathode sides, the gas-permeable layers sandwiching the membrane electrode assembly therebetween, and a separator on at least one of the anode and cathode sides; and
a gasket integrally molded with peripheral edges of the membrane electrode assembly and the gas-permeable layers of each of the stacked fuel cells.

2. The fuel cell module according to claim 1, wherein the separator has a protruding portion that protrudes laterally to an outer peripheral surface of the gasket, beyond the membrane electrode assembly and the gas-permeable layers, so that a stacked structure of the gasket and the protruding portion of the separator is formed.

3. The fuel cell module according to claim 1,
wherein:
each of the fuel cells has formed therein a plurality of manifolds for circulating at least one of a fuel gas, an oxidant gas, and a cooling medium,
the separators are provided on opposite sides of the module, and
a first endless sealing material is provided between separators of adjacent modules, the first endless sealing material being adapted to surround each manifold.

4. The fuel cell module according to claim 3,
wherein:
at least one of opposed surfaces of the separators of the adjacent modules has an endless concave groove formed therein, around the manifold, and
in a state in which the adjacent modules are stacked, part or all of the first sealing material is received in an endless space that is defined by the concave grooves of the two separators or in an endless space that is defined by the concave groove of one of the separators and a planar surface of the other separator.

5. The fuel cell module according to claim 1, wherein a peripheral edge of the separator is covered with the gasket such that the gasket is continuous over a peripheral edge of a single module.

6. The fuel cell module according to claim 1, further comprising a second elastic, endless sealing material provided between peripheral edges of opposed end surfaces of the adjacent modules.

7. The fuel cell module according to claim 1, wherein each of the gas-permeable layers includes one of a gas diffusion layer, a gas-flow-channel layer made of a porous metal body, and a stack of the gas diffusion layer and the gas-flow-channel layer.

8. A fuel cell stack formed by stacking and compressing the fuel cell modules according to claim 1.
